(19) United States
(12) Patent Application Publication
(10) Pub. No.: US 2024/0411667 A1
(43) Pub. Date: Dec. 12, 2024

(54) PROGRAM TRACING WITH TRACE SNIPPETS

(71) Applicant: Infineon Technologies AG, Neubiberg (DE)

(72) Inventors: Albrecht Mayer, Waakirchen (DE); Ibai Irigoyen Ceberio, Muenchen (DE); Gasper Skvarc Bozic, Unterhaching (DE)

(21) Appl. No.: 18/663,814

(22) Filed: May 14, 2024

Related U.S. Application Data
(60) Provisional application No. 63/507,656, filed on Jun. 12, 2023.

(51) Int. Cl. G06F 11/36

(52) U.S. Cl. CPC G06F 11/3636

(57) ABSTRACT

A system and method for tracing a cyclic program execution of a processing circuit of an integrated circuit. A trace unit of the integrated circuit captures trace snippets during respective occurrences of a hyper-period of the cyclic program execution of the processing circuit. A trace buffer of the integrated circuit stores the trace snippets. A processor, which is coupled to the integrated circuit, reconstructs the hyper-period by combining overlapping portions of the trace snippets from the trace buffer.

### BACKGROUND

An Integrated Circuit (IC) can be a microcontroller (MCU), a microprocessor (MPU), a system-on-chip (SoC), or any other IC that supports hardware tracing, enabling activity observation for debugging and performance analysis.

Trace data can be stored on-chip or exported via a trace interface. Implementing a high-speed connection for exporting can be costly or not feasible, especially in deeply embedded systems like automobiles. On-chip memory capture is usually enough for debugging, utilizing circular buffer recording and flexible triggering. Comprehensive analysis and profiling require extended traces involving continuous off-chip trace output to an external tool with ample memory.

Deeply-embedded control systems often exhibit cyclic behavior, with periodic task activation. For example, an automotive cycle involves receiving sensor data, processing the sensor data, making a decision based on the processed sensor data, and performing a task based on the decision. A trace containing only task switches and Interrupt Service Routine (ISR) entries and exits has a relatively low data rate. The trace can be transmitted or stored even with a slow off-chip interface or a large on-chip trace buffer if it is large enough for one hyper-period. However, this trace only provides task-level information and lacks insight into task behavior.

### BRIEF DESCRIPTION OF THE FIGURES

FIG. 1A illustrates an example trace reconstruction of a hyper-period in accordance with aspects of the disclosure.

FIG. 1B illustrates an example trace reconstruction of a hyper-period, with two detected flows, in accordance with aspects of the disclosure.

FIG. 2 illustrates a schematic diagram of an integrated circuit in accordance with aspects of the disclosure.

FIG. 3 illustrates a trace snippet example in accordance with aspects of the disclosure.

### DETAILED DESCRIPTION

This disclosure is directed to a trace unit of an integrated circuit capturing trace snippets during respective occurrences of a hyper-period of a cyclic program execution of a processing circuit of the integrated circuit and storing the trace snippets in a trace buffer of the integrated circuit. A processor coupled to the integrated circuit reconstructs the hyper-period by combining overlapping portions of the trace snippets from the trace buffer. The processor may alternatively or additionally extract profiling data through statistical methodologies.

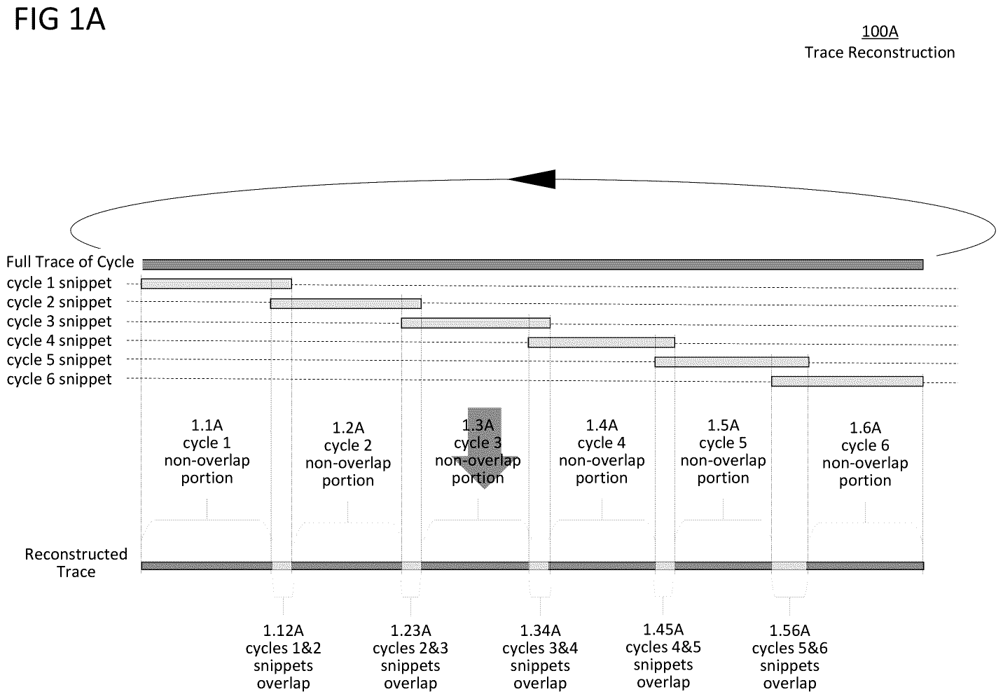

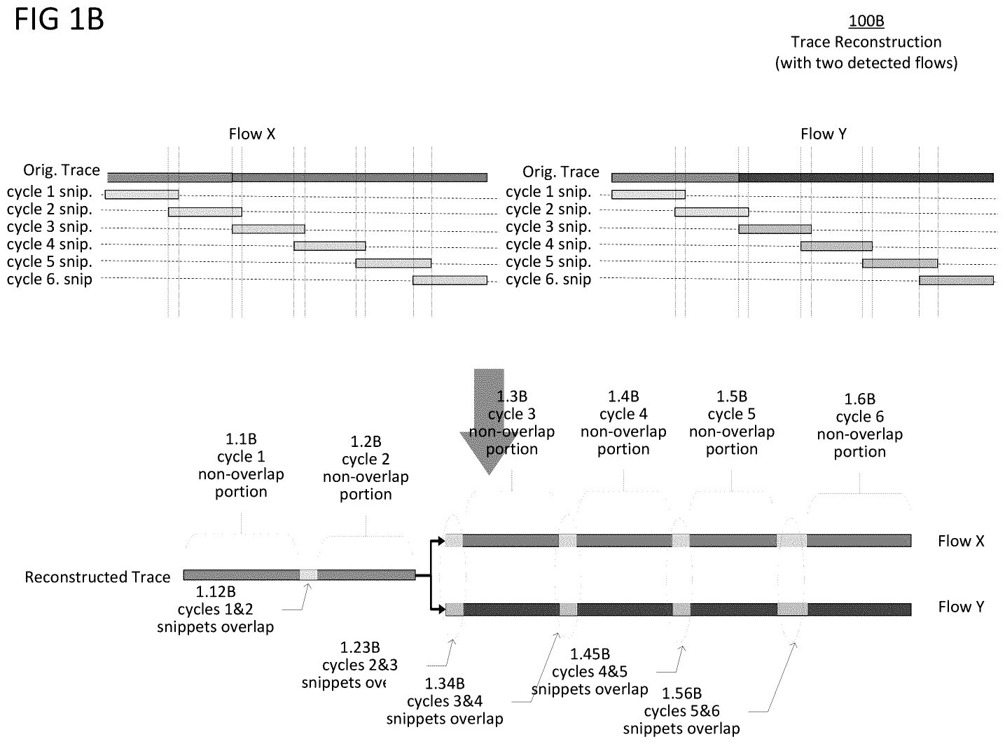

FIG. 1A illustrates an example trace reconstruction 100A of a hyper-period in accordance with aspects of the disclosure.

A hyper-period is when a task pattern starts repeating and is a multiple of all task periods, often matching the task period with the most prolonged interval. If no variations exist, a complete trace of one hyper-period is sufficient for analysis. To determine the hyper-period, a processor considers the individual periods of all tasks and finds the least common multiple of these periods. For instance, consider three tasks: T1 with a period of 3, T2 with a period of 4, and T3 with a period of 10. The processor examines the multiples of each task's period to calculate the hyper-period. For T1, the multiples are 3, 6, 9, 12, and so on. For T2, the multiples are 4, 8, 12, 16, and so on. Similarly, for T3, the multiples are 10, 20, 30, and so on. The hyper-period is the smallest multiple common to all these periods, which is 60. Therefore, in this example, the hyper-period is determined to be 60 based on the multiples of the individual task periods.

The example trace reconstruction 100A shows a complete trace of a hyper-cycle of cyclic program execution to be reconstructed. Reconstructing the hyper-period is simplified through the directed recording of trace snippets. There are potential variations in the execution across different hyper-period occurrences to be considered. In cases where respective occurrences of the hyper-period are substantially identical, a processor may reconstruct the full hyper-period by combining overlapping portions of the trace snippets at different time delays from the starts of the respective cycles or occurrences of the hyper-period. These time delays may gradually increase, for example. The overlapping portions are determined by determining portions of the trace snippets that are substantially identical.

Referring to the figure, the trace buffer captures trace snippets at gradually increasing delays from the start of the respective occurrences of the hyper-period through cycles 1-6. The processor reconstructs the hyper-period by combining overlapping portions of the trace snippets. As shown, the reconstructed trace, in time order, comprises cycle 1 non-overlap trace snippet portion 1.1A, cycles 1 and 2 trace snippets overlap 1.12A, cycle 2 non-overlap trace snippet portion 1.2A, cycles 2 and 3 trace snippets overlap 1.23A, cycle 3 non-overlap trace snippet portion 1.3A, cycles 3 and 4 trace snippets overlap 1.34A, cycle 4 non-overlap trace snippet portion 1.4A, cycles 4 and 5 trace snippets overlap 1.45A, cycle 5 non-overlap trace snippet portion 1.5A, cycles 5 and 6 trace snippets overlap 1.56A, and cycle 6 non-overlap trace snippet portion 1.6A.

FIG. 1B illustrates an example trace reconstruction 100B of a hyper-period, with two detected flows X and Y, in accordance with aspects of the disclosure. The flows X and Y may be from two processing circuits executing cyclic programs or, alternatively, from two different process flows within the same processing circuit. FIG. 1B includes similar reference numbers as FIG. 1A, wherein similar descriptions apply. Further description here is therefore not deemed to be necessary.

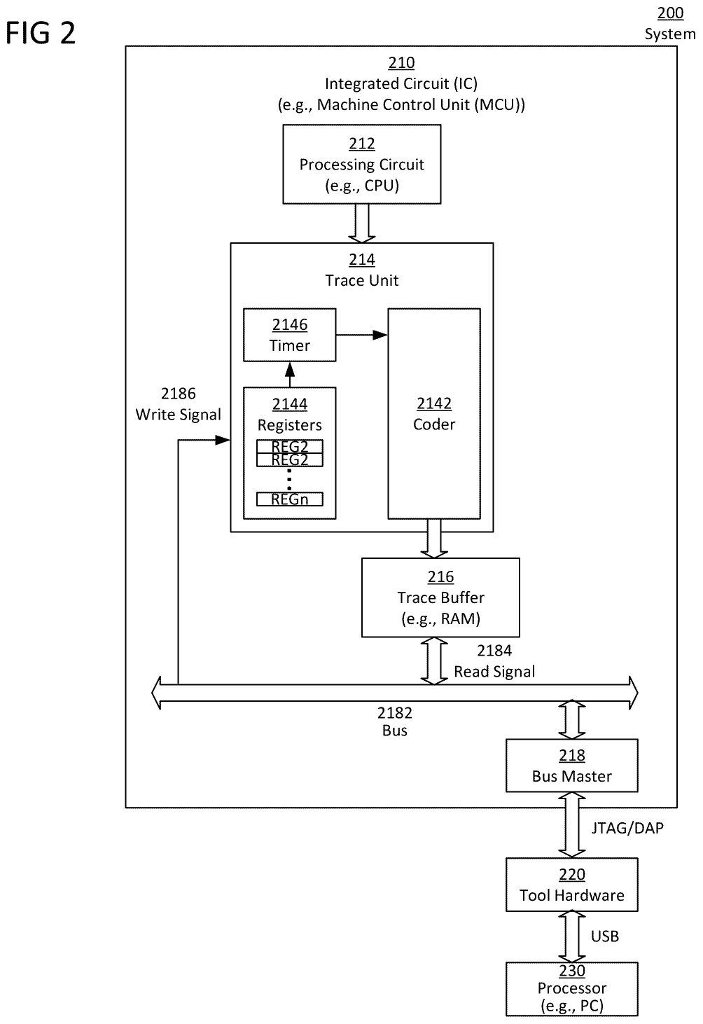

FIG. 2 illustrates a schematic diagram of system 200 in accordance with aspects of the disclosure.

System 200 comprises an integrated circuit (IC) 210 coupled to a processor 230 via tool hardware 220. The IC 210 comprises a processing circuit 212, a trace unit 214, a trace buffer 216, a bus master 218, and a bus 2182.

The processing circuit 212 is operable to execute a program, which in this case is a cyclic program, and outputs to the trace unit 214 program execution information. The processing circuit 212 may be a Central Processing Unit (CPU), although the disclosure is not limited in this respect. The processing circuit 212 may be any processing circuit within the IC 210, although a CPU generally provides the most helpful information.

The trace unit 214 is operable to capture trace snippets of the program execution information received from the processing circuit 212. The trace unit 214 may operate according to a standard, such as Nexus or IEEE-ISTO (Institute of Electrical and Electronics Engineers-Industry Standards and Technology Organization) 5001-2003, a standard debugging interface for embedded systems.

Trace unit 214 comprises coder 2142, registers 2144, and timer 2146. The coder 2142 is operable to capture the trace snippets. The registers 2144 are operable to store trace capture trigger information used to trigger the coder 2142 to begin trace snippet captures. The registers 2144 may also store information indicating which processing circuit 212 the coder 2142 is to trace. The trace snippets may comprise program flow information and/or task information. The program flow information and/or task information may be limited to call information and/or return information, although the disclosure is not limited in this respect.

The trace unit 214 is operable to capture trace snippets during respective occurrences of a hyper-period of cyclic program execution of the processing circuit 212. The trace unit 214 is operable to capture the trace snippets at different time delays from the start of the respective occurrences of the hyper-period. The timer 2146 is operable to enable, based on the trace capture trigger information received from registers 2144, the coder 2142 to start capturing each trace snippet. When timer 2146 determines that the time matches the time stored in register 2144, timer 2146 triggers coder 2142 to capture a trace snippet.

The hyper-period may be reconstructed on a per-task basis, in which case the trace unit 214 captures those trace snippets for a particular task where the task identification is known are utilized. In real-world scenarios, there might be slight deviations in the behavior during the hyper-period, leading to different task execution patterns across hyper-periods. A cyclic program interacts with the outside world, such as an automobile. And even if the automobile sensors consistently deliver the same sensor data, there might be slight variations in the timing due to interrupts.

An interrupt received from external hardware will result in variations in the hyper-cycle occurrences. During trace capture of a task, trace unit 214 is operable to pause trace snippet capture following an interrupt until a return. For example, if the program flow is A, B, C, D, and after A, B, there is an interrupt X, Y, the program returns from the interrupt to execute C, D. The trace unit 214 determines that X, Y was within an interrupt to be ignored.

Each of the trace snippets may comprise a position of a task within the hyper-period. The execution of high-frequency tasks may depend on the state of the slower tasks. The position of the task within the hyper-period may be a time offset from the start of the hyper-period.

In an alternative aspect, the trace unit 214 may be operable to capture the trace snippets at random time delays from the start of the respective occurrences of the hyper-period. This random approach could necessitate an extensive collection of trace snippets for a complete analysis.

Trace unit 214 is operable to store the captured trace snippets in trace buffer 216, which may be a circular buffer. The trace buffer 216 may be, for example, Random Access Memory (RAM), but the disclosure is not limited in this respect. The trace buffer 216 is generally a circular trace buffer and may be any type of memory suitable.

The processor 230 is coupled to the bus master 218 of the IC 210 via tool hardware 220. For example, the processor 230 may be connected to the tool hardware 220 by a Universal Serial Bus (USB) interface. The tool hardware 220 may be coupled to the bus master 218 of the IC 210 by a Joint Test Action Group (JTAG) interface, a Device Access Point (DAP) interface, or the like.

The processor 230 is operable to write the trace capture trigger information into the registers 2144 by transmitting a write signal 2186 via the tool hardware 220, bus master 218, and bus 2182. The trace capture trigger information is used to instruct the trace unit 214 when to capture trace snippets. This trace capture trigger information may be task identification information and/or time delay information.

A simple example is triggering trace capture based simply on time. The processor 230 stores in the registers 2144 a threshold delay time after restarting. After a hyper-period starts or after execution of the system 200 starts, the timer starts counting. When the timer expires, timer 2146 triggers coder 2142 to capture a trace snippet. Alternatively, the triggering could also be based on task execution. When a task switch occurs, the processing circuit 212 outputs a particular address. If trace trigger information stored in registers 2144 matches this specific address, the start of this task is the start of the hyper-period, and timer 2146 triggers coder 2142 to start the respective trace captures of the task occurrences based on the different time delays stored in registers 2144.

The processor 230 is operable to read the trace snippets from the trace buffer 216 in response to sending a read signal 2184 to the trace buffer 216 via the tool hardware 220, bus master 218, and bus 2182. The processor 230 may reconstruct the hyper-period by combining overlapping portions of the trace snippets read from the trace buffer 216. The overlapping portions are identified by the program execution information in the snippet being substantially similar.

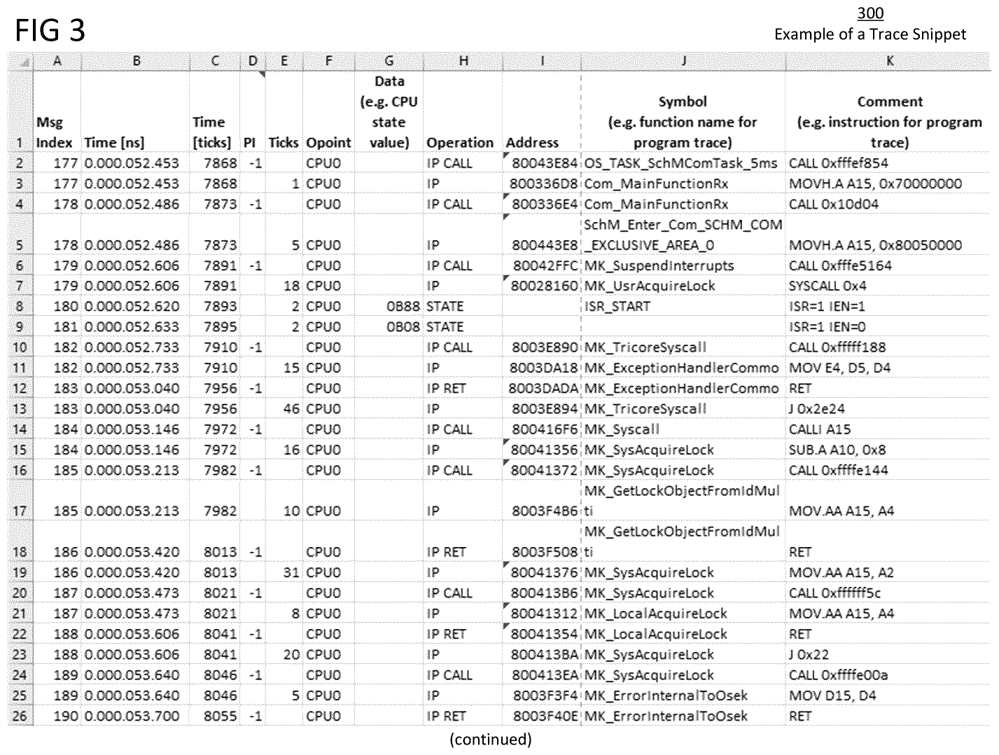

FIG. 3 illustrates a trace snippet example 300 in accordance with aspects of the disclosure. The snippet provides a visual representation of a trace log. Several columns are included to convey specific information about the trace messages.

In the “Msg Index” column, each row represents a unique message number. The “Time” column indicates the elapsed time since the start of the trace in nanoseconds. The “Time [ticks]” column represents the number of MCDS cycles that have elapsed since the beginning of the trace. It is a time measurement associated with CPU cycles. In this example, a tick corresponds to two clocks of the processing circuit 212, such as the CPU. The actual time is calculated from the ticks based on the system frequency.

The “PI” column denotes the program index. In cases where a trace message represents multiple instructions, the program index (PI) indicates the earlier instructions with negative indices. The “Ticks” column indicates the number of ticks that have elapsed since the previous message.

The “Opoint” column identifies the device that is being traced. In this example, it displays “CPU0” as the traced device. The “Data (e.g., CPU state value)” column displays the traced data values, specifically CPU state values in this instance. For read/write instructions, this column represents the value read from or written to memory.

The “Operation” column indicates the type of message being logged. Examples of message types shown include IP (Instruction Pointer), IP CALL, STATE, and IP RET (return). The “Address” column displays the location where the program code is stored. The “Symbol (e.g., function name for program trace)” column presents the name of the task being traced.

The “Comment (e.g., instruction for program trace)” column provides additional information clarifying the content of the message. In this example, it includes program instructions, and when tracing task execution, it may also represent the task state. An Interrupt Service Routine is denoted as ISR. An interrupt is initiated by the processing circuit 212, such as a CPU, when it is enabled. The interrupt is enabled before execution and becomes disabled afterward. “ISR=1|EN=1” signifies the start of an enabled interrupt, while “ISR=1|EN=0” indicates the end of a disabled interrupt.

The details of this example trace snippet 300 should be comprehensible to individuals with ordinary skill in the field. For the sake of conciseness, further explanations are omitted.

The subject matter of this disclosure offers several advantages. One benefit is conducting detailed and comprehensive profiling without expensive setups like specialized hardware tools or complex system designs. This makes it cost-effective and accessible to a wide range of users. Furthermore, it can be effectively utilized even when bandwidth is limited between the profiling tool and a target device. This is especially useful when dealing with deeply embedded target devices. Additionally, this disclosed subject matter proves valuable in field scenarios where bandwidth is constrained, and high and unpredictable latencies are present.

The techniques of this disclosure may also be described in the following examples.

Example 1. A method for tracing a cyclic program execution of a processing circuit of an integrated circuit, the method comprising: capturing, by a trace unit of the integrated circuit, trace snippets during respective occurrences of a hyper-period of the cyclic program execution of the processing circuit; storing the trace snippets in a trace buffer of the integrated circuit; and reconstructing, by a processor coupled to the integrated circuit, the hyper-period by combining overlapping portions of the trace snippets from the trace buffer.

Example 2. The method of example 1, wherein the capturing comprises: capturing the trace snippets at different time delays from start of the respective occurrences of the hyper-period.

Example 3. The method of any one or more of examples 1-2, wherein the trace snippets comprise program flow information and/or task information.

Example 4. The method of any one or more of examples 1-3, wherein the program flow information and/or task information comprises call information and/or return information.

Example 5. The method of any one or more of examples 1-4, wherein the trace snippets are associated with a same task.

Example 6. The method of any one or more of examples 1-5, wherein the capturing is paused during an interrupt that occurs during the same task.

Example 7. The method of any one or more of examples 1-6, wherein each of the trace snippets comprises a position of a task within the hyper-period.

Example 8. The method of any one or more of examples 1-7, wherein the position of the task within the hyper-period is a time offset from a start of the hyper-period.

Example 9. The method of any one or more of examples 1-8, wherein the capturing comprises: capturing the trace snippets at random time delays from starts of the respective occurrences of the hyper-period.

Example 10. A system, comprising: an integrated circuit comprising: a processing circuit; a trace unit operable to capture trace snippets during respective occurrences of a hyper-period of cyclic program execution of the processing circuit; and a trace buffer operable to store the trace snippets; and a processor coupled to the integrated circuit, and operable to reconstruct the hyper-period by combining overlapping portions of the trace snippets received from the trace buffer.

Example 11. The system of example 10, wherein the trace unit comprises: a coder operable to capture the trace snippets; registers operable to store trace capture trigger information; and a timer operable to enable, based on the trace capture trigger information received from the registers, the coder to start the capture of each of the trace snippets.

Example 12. The system of any one or more of examples 10-11, wherein the trace capture trigger information is task identification information and/or time delays from starts of the respective occurrences of the hyper-period, and the processor is operable to write the trace capture trigger information into the registers.

Example 13. The system of any one or more of examples 10-12, wherein the trace unit is operable to capture the trace snippets at different time delays from starts of the respective occurrences of the hyper-period.

Example 14. The system of any one or more of examples 10-13, wherein the trace snippets comprise program flow information and/or task information.

Example 15. The system of any one or more of examples 10-14, wherein the program flow information and/or task information comprises call information and/or return information.

Example 16. The system of any one or more of examples 10-15, wherein the trace snippets are associated with a same task.

Example 17. The system of any one or more of examples 10-16, wherein the trace unit is operable to pause the capture during an interrupt that occurs during the same task.

Example 18. The system of any one or more of examples 10-17, wherein each of the trace snippets comprises a position of a task within the hyper-period.

Example 19. The system of any one or more of examples 10-18, wherein the position of the task within the hyper-period is a time offset from a start of the hyper-period.

Example 20. The system of any one or more of examples 10-19, wherein the capturing comprises: capturing the trace snippets at random time delays from starts of the respective occurrences of the hyper-period.

While the foregoing has been described in conjunction with exemplary aspects, it is understood that the term “exemplary” is merely meant as an example, rather than the best or optimal. Accordingly, the disclosure is intended to cover alternatives, modifications, and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present disclosure. This disclosure is intended to cover any adaptations or variations of the specific aspects discussed herein.

What is claimed is:

1. A method for tracing a cyclic program execution of a processing circuit of an integrated circuit, the method comprising:
capturing, by a trace unit of the integrated circuit, trace snippets during respective occurrences of a hyper-period of the cyclic program execution of the processing circuit;
storing the trace snippets in a trace buffer of the integrated circuit; and
reconstructing, by a processor coupled to the integrated circuit, the hyper-period by combining overlapping portions of the trace snippets from the trace buffer.

2. The method of claim 1, wherein the capturing comprises:
capturing the trace snippets at different time delays from starts of the respective occurrences of the hyper-period.

3. The method of claim 1, wherein the trace snippets comprise program flow information and/or task information.

4. The method of claim 3, wherein the program flow information and/or task information comprises call information and/or return information.

5. The method of claim 1, wherein the trace snippets are associated with a same task.

6. The method of claim 5, wherein the capturing is paused during an interrupt that occurs during the same task.

7. The method of claim 1, wherein each of the trace snippets comprises a position of a task within the hyper-period.

8. The method of claim 7, wherein the position of the task within the hyper-period is a time offset from a start of the hyper-period.

9. The method of claim 1, wherein the capturing comprises:
capturing the trace snippets at random time delays from starts of the respective occurrences of the hyper-period.

10. A system, comprising:
an integrated circuit comprising:
a processing circuit;
a trace unit operable to capture trace snippets during respective occurrences of a hyper-period of cyclic program execution of the processing circuit; and
a trace buffer operable to store the trace snippets; and
a processor coupled to the integrated circuit, and operable to reconstruct the hyper-period by combining overlapping portions of the trace snippets received from the trace buffer.

11. The system of claim 10, wherein the trace unit comprises:
a coder operable to capture the trace snippets;
registers operable to store trace capture trigger information; and
a timer operable to enable, based on the trace capture trigger information received from the registers, the coder to start the capture of each of the trace snippets.

12. The system of claim 11, wherein the trace capture trigger information is task identification information and/or time delays from starts of the respective occurrences of the hyper-period, and the processor is operable to write the trace capture trigger information into the registers.

13. The system of claim 10, wherein the trace unit is operable to capture the trace snippets at different time delays from starts of the respective occurrences of the hyper-period.

14. The system of claim 10, wherein the trace snippets comprise program flow information and/or task information.

15. The system of claim 14, wherein the program flow information and/or task information comprises call information and/or return information.

16. The system of claim 10, wherein the trace snippets are associated with a same task.

17. The system of claim 16, wherein the trace unit is operable to pause the capture during an interrupt that occurs during the same task.

18. The system of claim 10, wherein each of the trace snippets comprises a position of a task within the hyper-period.

19. The system of claim 18, wherein the position of the task within the hyper-period is a time offset from a start of the hyper-period.

20. The system of claim 10, wherein the capturing comprises:
capturing the trace snippets at random time delays from starts of the respective occurrences of the hyper-period.
